(19) United States
(12) Patent Application Publication
(10) Pub. No.: US 2012/0034874 A1
(43) Pub. Date: Feb. 9, 2012

(54) APPARATUSES AND/OR METHODS OF INTERFERENCE MITIGATION AND/OR RATE IMPROVEMENT VIA UNCOORDINATED BEAMFORMING IN HETEROGENEOUS NETWORKS

(76) Inventors: Simon YIU, Jersey City, NJ (US); Doru Calin, Manalapan, NJ (US); Chan-Byoung Chae, Jersey City, NJ (US); Kai Yang, Princeton, NJ (US)

(21) Appl. No.: 12/938,728

(22) Filed: Nov. 3, 2010

Related U.S. Application Data
(60) Provisional application No. 61/371,246, filed on Aug. 6, 2010.

(51) Int. Cl. H04B 15/00; H04B 17/00

(52) U.S. Cl. 455/63.1; 455/67.11; 455/67.13

(57) ABSTRACT

A method of selecting beamforming vectors for a first transmitter and a first receiver communicating via a first communication link to reduce interference at a second transmitter and a second receiver communicating via a second communication link includes estimating a transmission null space for the second transmitter with respect to the first receiver and estimating a reception null space for the second receiver with respect to the first transmitter. The method further includes determining a first transmission beamforming vector for the first transmitter that falls within the estimated reception null space, and determining a first reception beamforming vector for the first receiver that falls within the estimated transmission null space.

### PRIORITY INFORMATION

This application claims priority on U.S. Provisional Application No. 61/371,246 filed Aug. 6, 2010, the entire contents of which are hereby incorporated by reference.

### BACKGROUND OF THE INVENTION

A communication system including two users sharing the same spectrum is considered. The network model under consideration is depicted in FIG. 1 where solid lines represent desired signals and dashed line represent interference. The first user 10 can be a user belonging to a macro network 20 or a primary user in a cognitive network. The second user 30 can be a user in a small cell network 40 or a secondary user in a secondary cognitive network. The first and second user 10 and 30 may be wireless phones, wireless equipped computers, or any wireless equipped user device. The macro and small cell networks 20 and 40 may include base station devices, controllers, etc. as is known in the art.

A problem in the above network model is the cross interference created between the networks. Accordingly, it would be beneficial to eliminate or reduce the interference while maximizing the sum rate, which is the bits per second per hertz that can be transmitted over a channel. More desirably, this should be achieved without requiring any cooperation from the primary user 10. It is desirable to do so for example in ad hoc networks or networks where the primary user is the one who pays for the spectrum and therefore should not be required to modify its transmission strategy to avoid interfering with the secondary user.

Spectrum sensing is usually employed to address this problem. The secondary user 30 tries to detect if the spectrum is occupied by the primary user 10 and only transmits if the spectrum is not being used by the primary user 10. Essentially, it is a detection problem and therefore, there is a tradeoff between the probability of a false alarm and the probability of detection. A high probability of detection results in a high probability of false alarm and similarly a low probability of false alarm results in a low probability of detection. The former is not desirable because the secondary user 30 does not transmit even if the spectrum is not being used while the later is not desirable because interference will result. If global channel state information (CSI) is known at both the primary and secondary users 10 and 30, it is possible to use beamforming techniques to eliminate the cross interference. However, this method is not attractive because the primary user 10 has to know the CSI of the secondary user 30—an unrealistic assumption in practical system deployments.

### SUMMARY OF THE INVENTION

The present invention is directed to apparatuses and/or methods of mitigating interference and/or improving transmission rate via uncoordinated beamforming in heterogeneous networks.

For example, a method of selecting beamforming vectors for a first transmitter and a first receiver communicating via a first communication link to reduce interference at a second transmitter and a second receiver communicating via a second communication link is provided. One embodiment of the method includes estimating a transmission null space for the second transmitter with respect to the first receiver, and estimating a reception null space for the second receiver with respect to the first transmitter. The method further includes determining a first transmission beamforming vector for the first transmitter that falls within the estimated reception null space, and determining a first reception beamforming vector for the first receiver that falls within the estimated transmission null space.

In an embodiment, the estimating a transmission null space estimates the transmission null space without knowledge of the beamforming vector used by the second transmitter, and the estimating a reception null space estimates the reception null space without knowledge of the beamforming vector used by the second receiver.

As another example, an embodiment of an apparatus is a first transmitter communicating via a first communication link with a first receiver configured to reduce interference at a second transmitter and a second receiver communicating via a second communication link by determining (1) a first transmission beamforming vector for the first transmitter that falls within an estimated reception null space and (2) a first reception beamforming vector for the first receiver that falls within the estimated transmission null space. The transmission null space is for the second transmitter with respect to the first receiver, and the reception null space is for the second receiver with respect to the first transmitter.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates an example network model under consideration.

FIG. 2 illustrates a detailed abstraction of the network model under consideration.

FIG. 3 illustrates a flow chart of a method for interference mitigation and rate improvement according to an embodiment.

FIG. 4 illustrates a flow chart of a method for interference migration and rate improvement according to another embodiment.

### DETAILED DESCRIPTION OF THE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Exemplary embodiments are discussed herein as being implemented in a suitable computing environment. Although not required, exemplary embodiments will be described in the general context of computer-executable instructions, such as sections, program modules or functional processes, being executed by one or more computer processors or CPUs. Generally, sections, program modules or functional processes include routines, programs, objects, components, data structures, etc. that performs particular tasks or implement particular abstract data types. The sections, program modules and functional processes discussed herein may be implemented using existing hardware in existing communication networks. For example, sections, program modules and functional processes discussed herein may be implemented using existing hardware at existing network elements, servers or control nodes. Such existing hardware may include one or more digital signal processors (DSPs), application-specific-integrated-circuits, field programmable gate arrays (FPGAs) computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at limes referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

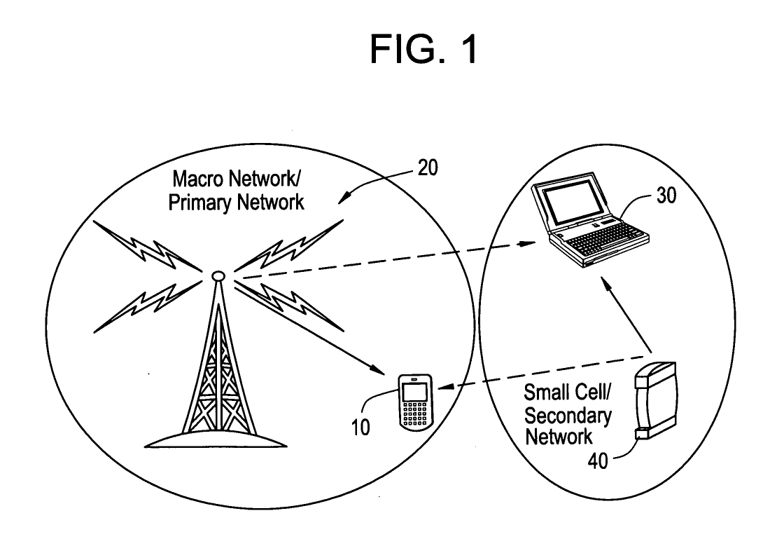

For the purposes of discussion the communication system including a primary user 10 and a secondary user 30 operating in the same spectrum as shown in FIG. 1 and discussed above will be considered. As discussed above, the primary user 10 can be a user in a macro network 20 while the secondary user 30 can be a user in the small cell 40. For the purposes of discussion, the macro network 20 may be more generically referred to as the primary transmitter 20, the primary user 10 may be referred to as the primary receiver 10, the small cell 40 may be referred to as the secondary transmitter 40, and the second user 30 may be referred to as the secondary receiver 30. However, it will be appreciated that the primary transmitter 20 and the second transmitter 40 may receive, and the primary receiver 10 and the secondary receiver 30 may transmit. Accordingly, the methods discussed below may also be applied in reverse to the description provided.

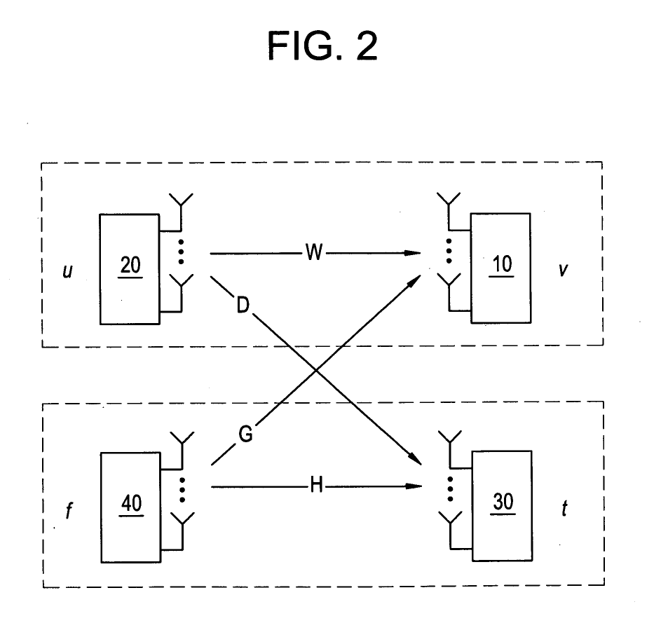

FIG. 2 illustrates a detailed abstraction of the network model under consideration. Here, the primary transmitter 20 and receiver 10 are equipped with Nₜ^{P} and Nᵣ^{P} antennas, respectively. Likewise, the secondary transmitter 40 and receiver 30 are equipped with Nₜ^{C} and Nᵣ^{C} antennas, respectively. All antennas are assumed to be uncorrelated. Furthermore, we assume that the channel is frequency non-selective which can be easily achieved by using multiple-input multiple-output orthogonal frequency division multiplexing (MIMO-OFDM). Note that, however, this solution is not directly related to the channel model. Once channel information is known, the cognitive transmitter and receiver can compute the transmit/receive beamforming vectors using the embodiments of the present invention.

The MIMO channel or primary link between the primary transmitter 20 and receiver 10 is denoted by W whereas the secondary or cognitive link between the secondary transmitter 40 and receiver 30 is denoted by H. The interference channel from the primary transmitter 20 to the secondary receiver 30 is denoted by D and the interference channel from the secondary transmitter 40 to the primary receiver 10 is denoted by G. We model the individual channel elements in W, H, D, and G, as independent and identically distributed (i.i.d.) zero-mean complex Gaussian random variables with unit variance (Rayleigh fading). The primary transmitter 20 employs a beamforming vector u for the transmission of its data symbol x_{P}. Note that we consider the transmission of a single stream of information in the primary link. Of course this is not optimal from the information theory perspective. However, we note that this assumption is not restrictive. The results presented are also valid for the case of spatial multiplexing. We consider a single stream of information only for ease of conveying the main idea. At the cognitive link, the secondary transmitter 40 employs a beamforming vector f for the transmission of its data symbol x_{C}. Here, x_{P} and x_{C} are assumed to be complex zero-mean unit variance random variables. Furthermore, let v and t be the receive combining vector for the primary and secondary receivers 10 and 30, respectively. Finally, we impose a unit energy constraint on all beamforming vectors, i.e., u*u=f*f=v*v=t*t=1.

Let P_{L} and P_{C} be the transmit power at the primary and secondary transmitters 20 and 40, respectively, the received signals at the primary receiver 10 and the secondary receiver 30 are given respectively by:

r_{P}=\sqrt{Ppv}*Wux_{P}+P_{P}v*Gfx_{c}+v*n_{P} (1)

and

r_{C}=\sqrt{Pct}*Hfx_{c}+Pct*Dux_{P}+t*n_{c}. (2)

The elements in the noise vectors np and nc are modeled as i.i.d. zero-mean complex. Gaussian random variables with variance σ_{P}² and σ_{C}², respectively. The resulting signal to-interference-plus-noise ratio (SINR) of the primary and secondary links are given respectively by:

$$\begin{matrix}{SINR}_{P} = \frac{{P}_{P} v * W * uu * Wv}{{P}_{P} v * Gff * G * v + v * v {σ}_{P}^{2}} & ( 3 ) \\ {SINR}_{C} = \frac{Pct * H * f f * Ht}{Pct * Duu * D * t + t * t {σ}_{C}^{2}} & ( 4 )\end{matrix}$$

From equations (3) and (4), in order to achieve zero interference, the beamforming vectors v, f, t, and u have to be designed such that v*Gf=0 and t*Du=0. In addition to guaranteeing zero interference, another goal maybe to maximize the sum rate. For a single stream transmission, the sum rate is given by:

Rs=log₂ (1+SINR_{P})+log₂(1+SINR_{C}). (5)

Therefore, the design problem can be mathematically formulated as:

$$\{ {v}_{opt} , {f}_{opt} , {t}_{opt} , {u}_{opt} \} = {arg max}_{v , f , t , u} \{ {log}_{2} ( 1 + {SINR}_{P} ) + {log}_{2} ( 1 + {SINR}_{C} ) \} \\ \begin{matrix}\begin{matrix} subject to \{ \begin{matrix}v * Gf = 0 and t * Du = 0 \\ u * u = f * f = v * v = t * t = I\end{matrix} & \end{matrix} & \end{matrix} \qquad ( 6 )$$

Considering the first constraint of equation (6), zero interference can be achieved by appropriately designing v or f and t or u. We assume that the secondary user 30 is transparent to the primary user 10 since the performance of the primary user 10 should not be affected by the secondary link. To achieve zero interference caused to the primary receiver 10, the secondary transmitter 40 can beamform in the null space of v*G. Likewise, at the secondary receiver 40 the receive beamforming vector t can be designed such that it is in the null space of Du in order to avoid the interference caused by the primary transmitter 20. Note that v*G is an 1×Nₜ^{C} vector and the dimension of its null space is Nₜ^{C}−1. Similarly, the dimension of Du is Nᵣ^{C}×1 and the dimension of its null space is Nᵣ^{C}−1. The optimization problem in (6) now becomes:

$$\begin{matrix}\{ {v}_{opt} , {f}_{opt} , {t}_{opt} , {u}_{opt} \} = {arg max}_{v , f , t , u} \{ {log}_{2} ( 1 + {SINR}_{P} ) + {log}_{2} ( 1 + {SINR}_{C} ) \} & ( 7 ) \\ subject to \{ \begin{matrix}f ∈ Null ( {v}_{opt} * G ) and t ∈ Null ( {Du}_{opt} ) \\ u * u = f * f = v * v = t * t = I\end{matrix} & \end{matrix}$$

Having achieved zero interference both at the primary and secondary receivers 10 and 30, the remaining question is how to maximize the sum rate in equation (5). The first constraint in equation (7) shows that f depends on v, and t depends on u. The sum rate optimal solution requires finding v and u such that R_{S} is maximized and the optimal solution requires the knowledge of W, H, D, and G, i.e., the global channel state information (CSI). This is not reasonable from the primary user's point of view because the primary user 20/10 should not be required to know the existence of the secondary user 30/40. Therefore, it is reasonable for the primary user 20/10 to simply optimize v and u to maximize its own rate assuming no interference from the secondary transmitter 30. After obtaining v and u, the secondary user 30/40 can choose f and t (which are functions of v and u, respectively, cf. the first constraint of (7)) to maximize its own rate.

The rate of the primary user 20/10 can be maximized by appropriately designing v and u. Since no interference is created at the primary user 20/10 and the only constraint for the beamforming vectors v and u is the energy constraint, standard approaches in existing literature can be used to design v and u to maximize the rate of the Nₜ^{P}×Nᵣ^{P} interference-free MIMO link. Since we restrict ourselves to the transmission of a single stream of information, the spectral efficiency can be maximized by maximizing the SINR due to the monotonic property of the logarithm function. It is well known that the SINR maximizing receive beamformer for a point-to-point link is the maximal ratio combining beamformer. In this case, the receive beamforming vector is simply vopt=Wu/\sqrt{u*W*Wu}. With this design and the zero interference condition, equations (1) becomes:

$${r}_{p} = \frac{\sqrt{{P}_{P}} u * W * {W}_{u}}{\sqrt{u * W * Wu}} {χ}_{P} + \frac{u * W *}{\sqrt{u * W * Wu}} {n}_{P} \qquad ( 8 )$$

and the corresponding instantaneous SINR is given by:

$${SINR}_{P} = \frac{{P}_{P} u * W * Wu}{{σ}_{P}^{2}} \qquad ( 9 )$$

The spectral efficiency of the primary link log2(1+SINR_{P}) can be maximized by beamforming in the direction of the eigenvector corresponding to the largest eigenvalue of W*W. We denote the optimal transmit beamforming vector as uₒₚₜ. Using again the monotonic property of the logarithm function, the spectral efficiency of the cognitive link can be maximized by maximizing SINR_{C}. To maximize the SINR of the cognitive communication link, the design of f and t is not as flexible as the one for v and u. This is because the feasible values of f and t are now constrained by the zero interference requirement. Specifically, the optimal beamformers are given by:

$$\{ {f}_{opt} , {t}_{opt} \} = {argmax}_{f , t} \frac{{P}_{C} t * Hff * H * t}{t * t {σ}_{C}^{2}}$$

$$subject to \{ \begin{matrix}f ∈ Null ( {v}_{opt}^{*} G ) and t ∈ Null ( {Du}_{opt} ) \\ f * f = t * t = 1\end{matrix}$$

Next, three example embodiments solving the optimization problem, assuming that the primary user 20/10 has completely no knowledge of the secondary user 40/30 while achieving zero interference at both receivers, will be described.

Let F and T be the set of basis vectors which span the null space of v*ₒₚₜG and Duₒₚₜ, respectively. Note that the cardinality of F and T are Nₜ^{C}−1 and Nᵣ^{C}−1, respectively. The instantaneous SINR of the cognitive link given by:

$${SINR}_{C} = \frac{{P}_{C} t * Hff * H * t}{t * t {σ}_{C}^{2}} \qquad ( 12 )$$

can be maximized by performing an exhaustive search in F and T, i.e.:

$$\{ {f}_{discrete} , {t}_{discrete} \} = \frac{argmax}{f ∈ F , t ∈ T} \frac{{P}_{C} * Hff * H * t}{t * t {σ}_{C}^{2}} \qquad ( 13 )$$

Note that for Nₜ^{C}=Nᵣ^{C}=2, there is only one vector in the set F and T. In general, Nₜ^{C}−1×Nᵣ^{C}−1 computations are required to obtain the best beamformers f_{discrete} and t_{discrete}. Although zero interference can always be guaranteed at both receivers by selecting the beamformer pairs f, t as in (13), the obtained solution is not optimal in the sense of maximum sum rate because the search in (13) is not carried out over the entire null space of v*ₒₚₜG and Duₒₚₜ.

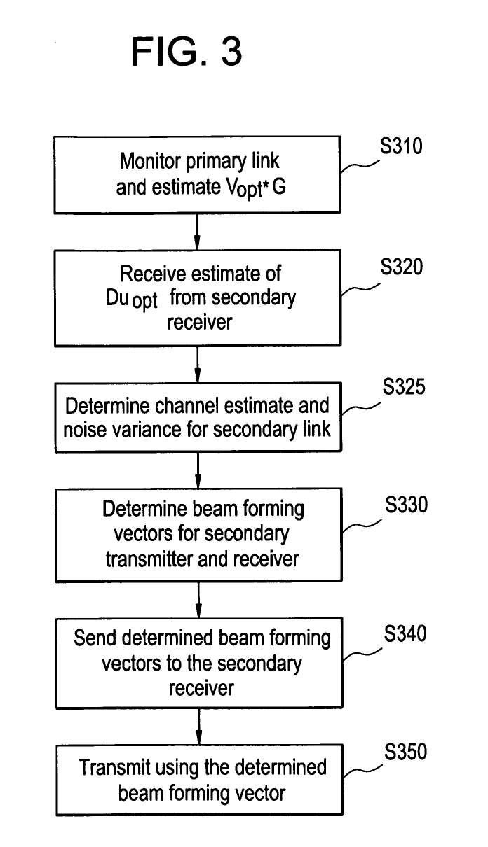

FIG. 3 illustrates an embodiment employed by the secondary transmitter 40 for implementing this method. As shown, in step S310, the secondary transmitter 40 monitors transmissions from the primary receiver 10. Using any well-known channel estimation technique, the secondary transmitter 40 estimates v*ₒₚₜG, and from this determines the null space of v*ₒₚₜG. In the same manner, the secondary receiver 30 estimates the null space of Duₒₚₜ, and reports this estimate to the secondary transmitter 40 over, for example, a dedicated control channel. The secondary transmitter 40 receives this estimate in step S320.

Next, in step S325, the secondary transmitter 40 estimates the secondary link H using any well-known channel estimation technique and determines the noise variance of the secondary link H using any well-known technique. Alternatively, the secondary receiver 30 estimates the secondary link H and noise variance, and communicates this to the secondary transmitter 40 over the dedicated control channel. The second transmitter 40 determines the beamforming vectors f and t for the secondary transmitter 40 and the secondary receiver 30 according to equation (13) in step S330. The secondary transmitter 40 sends the determined beamforming vectors to the secondary receiver 30 over the dedicated control channel in step S340. The secondary transmitter 40 will transmit using the determined beamforming vector f in step S350. Similarly, the secondary receiver 30 will receive using the determined beamforming vector t.

Since any vector in the null space of v*ₒₚₜG and Duₒₚₜ satisfies the zero interference condition, there could be potentially other vectors in those spaces which yield a higher SINR_{C} than f_{discrete} and t_{discrete}. Suppose the columns of Ĝ and \hat{D} contain the basis vectors of the null space of v*ₒₚₜG and Duₒₚₜ, respectively. The optimal beamformers are in the form of:

$$\begin{matrix}f = \frac{\hat{G} a}{\sqrt{a * a}} and t = \frac{\hat{D} b}{\sqrt{b * b}} , & ( 14 ) \\ where a ∈ {ℂ}^{( {N}_{t}^{C} - 1 ) \times 1} and b ∈ {ℂ}^{( {N}_{r}^{C} - 1 ) \times 1} . & \end{matrix}$$

Namely, a and b are linear combination vectors that optimize the null space of v*ₒₚₜG and Duₒₚₜ, respectively. The constrained optimization problem in (10) can now be formulated as an unconstrained one whose goal is to find

$$a ∈ {ℂ}^{( {N}_{t}^{C} - 1 ) \times 1} and b ∈ {ℂ}^{( {N}_{r}^{C} - 1 ) \times 1}$$

such that the objective function in (10) is maximized, i.e.,

$$\{ {a}_{opt} , {b}_{opt} \} = {argmax}_{a , b} \{ \frac{{P}_{C} b * \hat{D} * H \hat{G} aa * \hat{G} * H * \hat{D} b}{b * ba * a {σ}_{C}^{2}} \} \qquad ( 15 )$$

Unfortunately, there is no closed-form solution to (15) and we have to resort to numerical methods to solve the problem. In particular, a simple gradient (steepest accent) algorithm can be used to obtain aₒₚₜ and bₒₚₜ and we denote the resulting solutions as a_{grad} and b_{grad}. Suppose f(a[i], b[i]) is the objection function in (15), the gradient algorithm is given by:

$$[ \begin{matrix}a [ i + 1 ] \\ b [ i + 1 ]\end{matrix} ] = [ \begin{matrix}a [ i ] \\ b [ i ]\end{matrix} ] + μ [ \begin{matrix}\partial ( a [ i ] , b [ i ] ) / \partial a [ i ] * \\ \partial ( a [ i ] , b [ i ] / \partial b [ i ] *\end{matrix} ] \qquad ( 16 )$$

where i is the discrete iteration index and p is the adaptation step size, which is a matter of design choice. Furthermore, the two gradients in (16) are given by:

$$\frac{\partial ( a [ i ] , b [ i ] )}{\partial a [ i ] *} = K [ ( ( b * ba * a ) ) ( {\hat{G}}^{*} H * \hat{D} bb * {\hat{D}}^{*} H \hat{G} a ) - ( a * \hat{G} * H * \hat{D} bb * \hat{D} * H \hat{G} a ) ( b * ba ) ]$$

$$and$$

$$\frac{\partial ( a [ i ] , b [ i ] )}{\partial a [ i ] *} = K [ ( b * ba * a ) ( {\hat{D}}^{*} H \hat{G} aa * {G}^{*} H * \hat{D} b ) - ( b \hat{D} D * H \hat{G} aa * \hat{G} * H * \hat{D} b ) ( a * ab ) ] ,$$

respectively, where K is an irrelevant constant because this constant may be accounted for by μ. The time index i is dropped in the two equations above for ease of presentation.

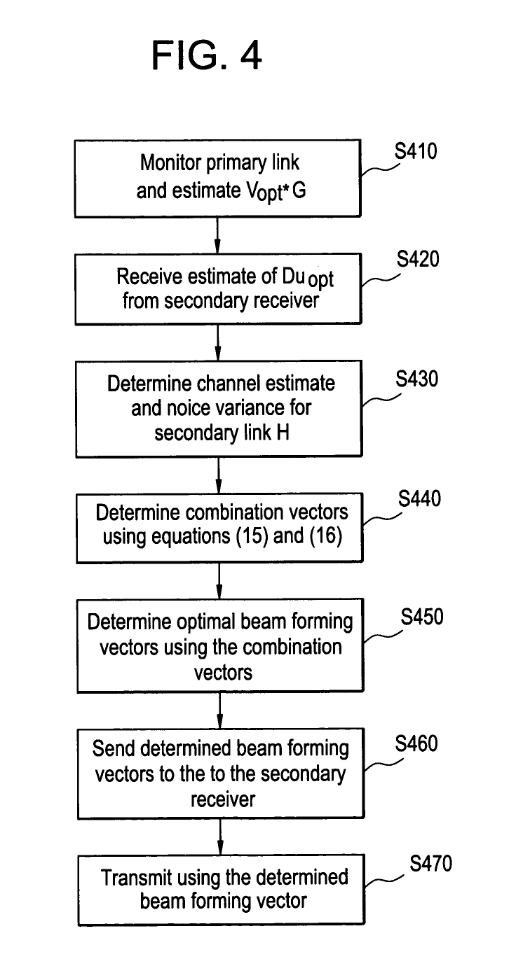

FIG. 4 illustrates an embodiment employed by the secondary transmitter 40 for implementing this method. As shown, in step S410, the secondary transmitter 40 monitors transmissions from the primary receiver 10. Using any well-known channel estimation technique, the secondary transmitter 40 estimates v*ₒₚₜG, and from this determines the null space of v*ₒₚₜG. In the same manner, the secondary receiver 30 estimates the null space of Duₒₚₜ, and reports this estimate to the secondary transmitter 40 over, for example, a dedicated control channel. The secondary transmitter 40 receives this estimate in step S420.

Next, in step S430, the secondary transmitter 40 estimates the secondary link H using any well-known channel estimation technique and determines the noise variance of the secondary link H using any well-known technique. Alternatively, the secondary receiver 30 estimates the secondary link H and noise variance, and communicates this to the secondary transmitter 40 over the dedicated control channel. The second transmitter 40 determines combination vectors a and b according to equations (15) and (16) in step S440. Then using equation (14), the second transmitter 40 determines the beamforming vectors f and t for the secondary transmitter 40 and the secondary receiver 30 in step S450. The secondary transmitter 40 sends the determined beamforming vectors to the secondary receiver 30 over the dedicated control channel in step S460. The secondary transmitter 40 will transmit using the determined beamforming vector f in step S470. Similarly, the secondary receiver 30 will receive using the determined beamforming vector t.

As mentioned above, there is no closed-form solution to equation (15). However, if we fix the number of receive antennas of the secondary receiver 30 to two, the joint optimization in equation (15) becomes a single (vector) variable optimization problem and a closed-form solution is feasible. First, rewrite equation (10) as:

$$\{ {f}_{opt} , {t}_{opt} \} = {argmax}_{f , t} \frac{{P}_{C } f * H * tt * Hf}{t * t {σ}_{C}^{2}} \qquad ( 17 )$$

assuming the same constraints as in (11). Suppose Nᵣ^{C}=2, the null space of Duₒₚₜ is one dimensional. Assume that the null space of Duₒₚₜ is spanned by tₒ and therefore, the receive beamforming vector at the secondary receiver 30 is given by topt=to. Recall that the optimal beamformers are in the fog of (14) and let:

ĥ=Ĝ*H*t₀, (18)

the optimization problem in (17) becomes:

$${a}_{opt} = {argmax}_{a} \frac{{P}_{C} a * \overline{h} \overline{h} * a}{a * a {σ}_{C}^{2}} \qquad ( 19 )$$

The argument in equation (19) (which is essentially the SINR of the cognitive receiver 30) is known as the generalized Rayleigh quotient and by invoking the Rayleigh's principle, it can be bounded by:

$$\frac{{P}_{C} {λ}_{min} ( \overline{h} \overline{h} *)}{{σ}_{C}^{2}} = \leq {SINR}_{C} = \frac{{P}_{C} a * \overline{h} \overline{h} * a}{a * a {σ}_{C}^{2}} \leq \frac{{P}_{C} {λ}_{min} ( \overline{h} \overline{h} *)}{{σ}_{C}^{2}} \qquad ( 20 )$$

Therefore, SINR_{C} can be maximized by choosing aₒₚₜ to be the eigenvector corresponding to the maximum eigenvalues of h̅ h̅*. Consequently, fₒₚₜ=Ĝaₒₚₜ. It is interesting to note that although there is no constraint on

$$a ∈ {ℂ}^{( {N}_{t}^{C} - 1 ) \times 1} ,$$

the optimal solution aₒₚₜ is always a unit vector.

Interference cancellation and rate maximization via uncoordinated beamforming in a cognitive network which includes a single primary and secondary user has been discussed. The secondary user was allowed to transmit concurrently with the primary user. The beamforming vectors of the secondary user were designed such that the interference is completely nullified both at the primary and secondary receivers while maximizing the rate of the primary link. Since no interference is created at the primary receiver, traditional approaches can be used to design the beamforming vectors or precoding matrices of the primary user.

The invention being thus described, it will be obvious that the same may be varied in many ways. For example, some of operations discussed above with respect to FIGS. 3 and 4, may be performed that secondary receiver 30 instead of the secondary transmitter 40. Such variations are not to be regarded as a departure from the invention, and all such modifications are intended to be included within the scope of the invention.

I/We claim:

1. A method of selecting beamforming vectors for a first transmitter and a first receiver communicating via a first communication link to reduce interference at a second transmitter and a second receiver communicating via a second communication link, comprising:
estimating a transmission null space for the second transmitter with respect to the first receiver;
estimating a reception null space for the second receiver with respect to the first transmitter;
determining a first transmission beamforming vector for the first transmitter that falls within the estimated reception null space; and
determining a first reception beamforming vector for the first receiver that falls within the estimated transmission null space.

2. The method of claim 1, wherein
the estimating a transmission null space estimates the transmission null space without knowledge of the beamforming vector used by the second transmitter; and
the estimating a reception null space estimates the reception null space without knowledge of the beamforming vector used by the second receiver.

3. The method of claim 2, wherein the determining a first transmission step and the determining a first reception step collectively determine the first transmission beam forming vector and the first reception beamforming vector to maximize a signal-to-noise ratio over the first communication link given the estimated transmission null space and the estimated reception null space.

4. The method of claim 3, wherein the collective determination is performed by considering a set of discrete, possible values for the first reception beamforming vector and the first transmission beamforming vector within the estimated reception null space and the estimate transmission null space, respectively.

5. The method of claim 3, wherein the collective determination is performed by maximizing an objective function including terms representing optimal beamformers for the first transmission beamforming vector and the first reception beam forming vector.

6. The method of claim 2, wherein the determining a first transmission beamforming vector step and the determining a first reception beamforming vector step collectively determine the first transmission beam forming vector and the first reception beamforming vector based on the estimated transmission null space, the estimated reception null space, a transmit power of the first transmitter, a channel estimate of the first communication link, and a noise variance of the first communication link.

7. The method of claim 6, wherein
the collective determination includes determining combination vectors that optimize the estimated transmission null space and the estimated reception null space; and
the determining combination vectors step is performed based on previously determined combination vectors.

8. The method of claim 2, wherein
the determining a first transmission beamforming vector step and the determining a first reception beamforming vector step collectively determine the first transmission beam forming vector and the first reception beamforming vector based on determining combination vectors that optimize the estimated transmission null space and the estimated reception null space; and
the determining combination vectors step is performed based on previously determined combination vectors.

9. The method of claim 1, wherein the determining a first transmission beamforming vector step and the determining a first reception beamforming vector step collectively determine the first transmission beam forming vector and the first reception beamforming vector to maximize a signal-to-noise ratio over the first communication link given the estimated transmission null space and the estimated reception null space.

10. The method of claim 9, wherein the collective determination is performed by considering a set of discrete, possible values for the first reception beamforming vector and the first transmission beamforming vector within the estimated reception null space and the estimate transmission null space, respectively.

11. The method of claim 9, wherein the collective determination is performed by maximizing an objective function including terms representing optimal beamformers for the first transmission beamforming vector and the first reception beam forming vector.

12. The method of claim 1, wherein the determining a first transmission beamforming vector step and the determining a first reception beamforming vector step collectively determine the first transmission beam forming vector and the first reception beamforming vector based on the estimated transmission null space, the estimated reception null space, a transmit power of the first transmitter, a channel estimate of the first communication link, and a noise variance of the first communication link.

13. The method of claim 12, wherein the collective determination includes determining combination vectors that optimize the estimated transmission null space and the estimated reception null space

14. The method of claim 13, wherein the determining combination vectors step is performed based on previously determined combination vectors.

15. The method of claim 1, wherein the determining a first transmission beamforming vector step and the determining a first reception beamforming vector step collectively determine the first transmission beam forming vector and the first reception beamforming vector based on determining combination vectors that optimize the estimated transmission null space and the estimated reception null space

16. The method of claim 15, wherein the determining combination vectors step is performed based on previously determined combination vectors.

17. A first transmitter communicating via a first communication link with a first receiver configured to reduce interference at a second transmitter and a second receiver communicating via a second communication link by determining (1) a first transmission beamforming vector for the first transmitter that falls within an estimated reception null space and (2) a first reception beamforming vector for the first receiver that falls within the estimated transmission null space, the transmission null space being for the second transmitter with respect to the first receiver, and the reception null space being for the second receiver with respect to the first transmitter.
